(19) United States
(12) Patent Application Publication
(10) Pub. No.: US 2014/0317256 A1
(43) Pub. Date: Oct. 23, 2014

(54) Loop and Outage Avoidance in Software Defined Network

(71) Applicant: CISCO TECHNOLOGY, INC., San Jose, CA (US)

(72) Inventors: Yu Jiang, Shanghai (CN); Jerry Ziyi Lu, Shanghai (CN); Jeffrey Cai, Shanghai (CN); Kevin Fang, Shanghai (CN)

(73) Assignee: Cisco Technology, Inc., San Jose, CA (US)

(21) Appl. No.: 13/865,240

(22) Filed: Apr. 18, 2013

(30) Foreign Application Priority Data
Apr. 17, 2013 (CN) 201310132997.1

(51) Int. Cl. H04L 12/751

(52) U.S. Cl. CPC H04L 45/02
USPC 709/223

(57) ABSTRACT

A controller, e.g., a software-defined network (SDN) controller, stores data representing a topology of a network that includes a plurality of network elements. A move is detected of a host between network elements in the network and a destination network element to which the host has moved is determined. The destination network element is designated as a root of a tree in the network. A topology for the tree is generated using the destination network element as the root of the tree. Following the topology of the tree, starting with the root, parent network elements in the tree are updated for a traffic flow for the host before child network elements are updated.

### TECHNICAL FIELD

The present disclosure relates to computer networks and more particularly to software-defined networks.

### BACKGROUND

In an OpenFlow/software-defined network (SDN), network topologies can change from time to time. For example, network elements may need to be taken out of service, hosts may need to be moved from one network element to another, etc. An SDN controller in the network tracks the network topology changes and updates flows to all effected network elements. Traditional network designs push all flow update messages to all effected devices concurrently, which may cause a loop of traffic between network elements, the result of which is unpredictable.

### BRIEF DESCRIPTION OF THE DRAWINGS

FIG. 1 is a block diagram of an example network topology in which a host moves between network elements, e.g., switches, and the resulting flows are updated according to techniques presented herein.

FIG. 2 is a block diagram of network elements shown in FIG. 1, but with network elements re-arranged in a new tree topology created when a host moves.

FIG. 3 is a high-level flow chart depicting operations performed by a controller to update network elements in the order of the new tree topology shown in FIG. 2.

FIG. 4 is a diagram showing the exchange of messages between the controller and a network element when the controller pushes a flow update to a network device.

FIG. 5 is an example block diagram of a controller configured to perform the update techniques presented herein.

### DESCRIPTION OF EXAMPLE EMBODIMENTS

### Overview

Techniques are presented to update network elements in a network when a host moves from one network element to another network element. A controller, e.g., a software-defined network (SDN) controller, stores data representing a topology of a network that includes a plurality of network elements. A move is detected of a host between network elements in the network and a destination network element to which the host has moved is determined. The destination network element is designated as a root of a tree in the network. A topology for the tree is generated using the destination network element as the root of the tree. Following the topology of the tree, starting with the root, parent network elements in the tree are updated for a traffic flow for the host before child network elements are updated.

### Example Embodiments

In a software-defined network (SDN)/OpenFlow-enabled network, a centralized SDN controller (herein simply referred to as a “controller”) provides management control for the individual network elements. OpenFlow is an open standard that enables researchers to run experimental protocols in networks. OpenFlow is added as a feature to commercial Ethernet switches, routers and wireless access points.

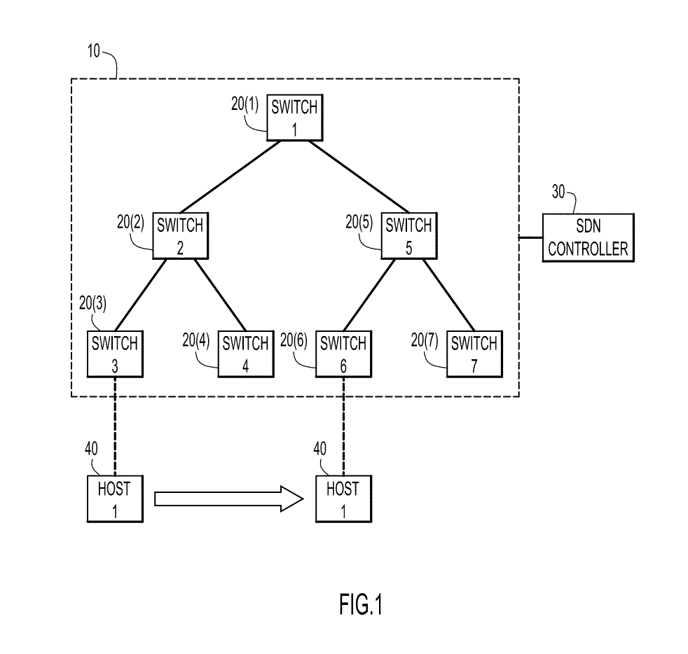

Referring first to FIG. 1, a diagram is shown of an example topology of a network 10. The network 10 includes a plurality of network elements, e.g., switches, 20(1)-20(7). In the topology shown in FIG. 1, network element 20(1) is a root node and network elements 20(2) and 20(5) are direct child nodes with respect to network element 20(1). Network elements 20(3) and 20(4) are direct child nodes with respect to network element 20(2). Network elements 20(6) and 20(7) are direct child nodes with respect to network element 20(5). The controller 30 communicates with each of the network elements in network 10 in order to push network updates, when necessary. The network elements may be switches, routers, and virtualized versions of such physical devices.

Host 40 (designated as “Host 1” in FIG. 1) is initially connected to a port of network element 20(3). Host 40 may be a computer, physical server, or virtual server (e.g., virtual machine). Host 40, for any of a variety of reasons, is moved from network element 20(3) to network element 20(6), on a different leaf in the network 10. When a host moves from one network element to another, the controller 30 needs to update the flow tables in the network elements so that traffic for the host that moved can be forwarded appropriately. If all of the network elements are updated concurrently, a loop back may result in a flow to/from the host. According to the techniques presented herein, when host 40 moves to a different network element, the controller 30 updates the network elements in a particular sequence or order so as to avoid any looping of traffic associated with the host 40 between two or more network elements.

Consider an example of a simple network topology of two switches, switch 1 and switch 2, and a host is initially connected to switch 2, but then moves to the switch 1. If existing flow update techniques are used, the switches are updated simultaneously. As a result, a flow associated with the host may be forwarded from switch 1 to switch 2, and then back from switch 2 to switch 1, never reaching its intended destination.

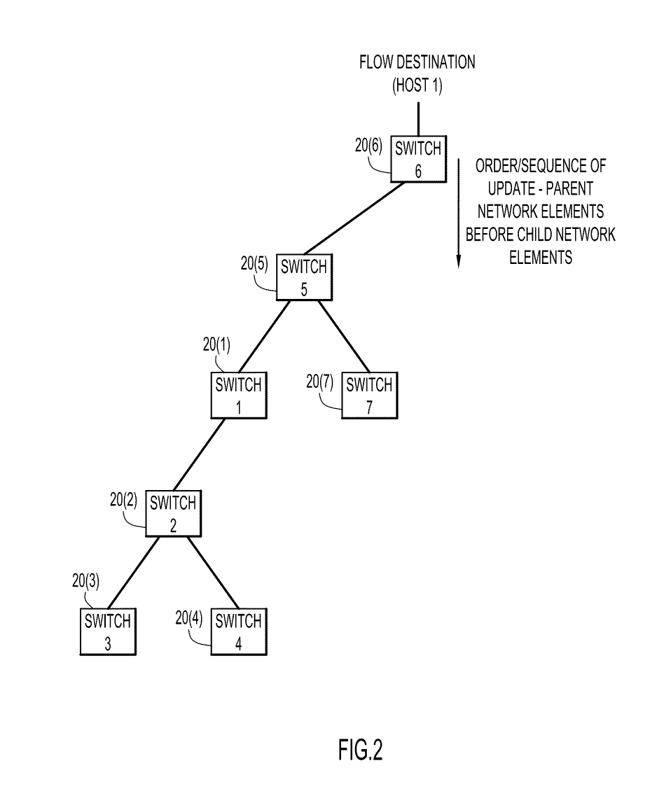

Turning now to FIG. 2, a diagram is described that generally depicts the sequence in which updates are made to network elements when a host moves between network elements. The destination network element, e.g., network element 20(6), to which the host 30 moves is designated as the new (exit interface) root of the tree in the network. A new network topology is created with the destination network device as the root of the tree for the new topology. For example, a “Prim's” algorithm may be used to generate a minimal spanning tree (MST) topology. FIG. 2 shows the topology created after the network element 20(6) is designated as the root of the tree. After the new topology is created with the root of the tree being the destination network element to which the host has moved, the update/programming by the SDN controller of the flow(s) for traffic to/from the host is pushed to the network elements in the tree in order of parent network elements before child network elements. For example, in the example of FIG. 2, the network element 20(6) is updated, followed by network element 20(5). After network element 20(5) is updated, network elements 20(1) and 20(7) are updated in any order, or in parallel (at the same time). After network elements 20(1) and 20(7) are updated, then network element 20(2), which is a child node with respect to network element 20(1), is updated. After network element 20(1) is updated, network elements 20(3) and 20(4) are updated. Again, since network elements 20(3) and 20(4) are child elements of network element 20(1), they may be updated in any order, or in parallel. By updating/programming the flow change in an OpenFlow/SDN for traffic to/from the host in this manner, it is possible to avoid network loop back and outage events.

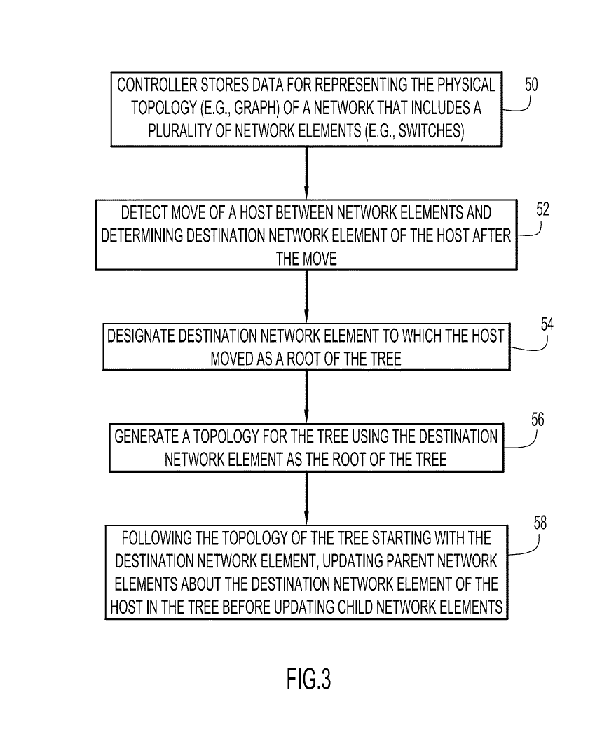

Reference is now made to FIG. 3 for description of a flow chart depicting the operations of the controller 30 to perform the update process depicted by FIG. 2. At 50, the controller generates and stores data representing a topology of a network that includes a plurality of network elements. The controller 30 performs operation 52 in the normal course of SDN management, and it may involve storing data representing the topology of physical and/or virtual switches in the network. At 52, the controller detects a move of a host between network elements in the network and determines a destination network element to which the host has moved. Numerous techniques are known in the art for detecting a move of a network element and determining the destination network element to which the host has moved. At 54, the controller sets or designates the destination network element to which the host moved as a root of a (new) tree topology for the network. At 56, the controller generates a topology for the (new) tree using the destination network element as the root of the tree. For example, the controller 30 may use Prim's algorithm to find a MST for a connected weighted graph of network elements. Furthermore, when the (new) topology is generated, it may be generated on the basis of network elements that are impacted by movement of the host and without regard to network elements not impacted by movement of the host. In other words, network elements impacted by movement of the host are included/accounted for in the generation of the new tree topology whereas network elements not impacted by the movement of the host are not included/accounted for in the generation of the new tree topology. At 58, following the topology of the (new) tree, controller, starting with the root, updates parent network elements in the tree before updating child network elements. Child network elements of the same parent network element may be updated in any order, or in parallel (at the same time as each other). In other words, flow table updates can be pushed simultaneously to two or more child network elements that are at the same level of the (new) tree formed after the host has moved, if their parent network element has already been updated. The network changes associated with the movement of the host are updated in such as way as to avoid network traffic loop or outage.

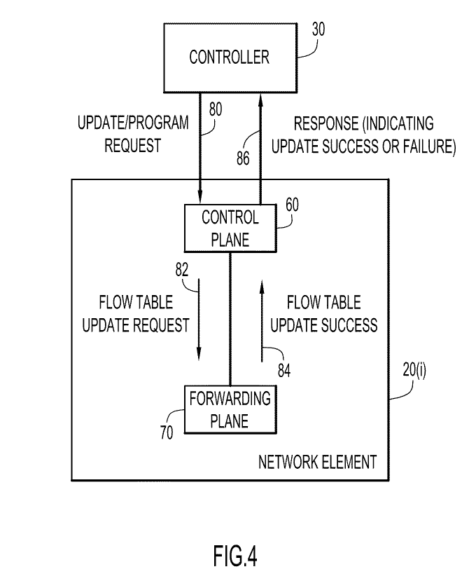

Reference is now made to FIG. 4 for a further description of the manner in which a flow update is pushed to a network element. A network element 20(i) is shown in FIG. 4 and is meant to generically refer to any of the network elements shown in FIG. 1. In the network element 20(i), there is a control plane 60 and a forwarding plane 70. The control plane 60 consists of the control element and supporting software/firmware that performs control operations of the network device and which responds to commands/controls received from the controller 30. When pushing a flow update to a network element 20(i), the controller 30 sends to the network element 20(i) an update/program request 80 that contains a flow table update (or several flow table updates) to be made for one of more traffic flows associated with the host. The control plane 60 receives the request 80 and sends a flow table update request 82 to the forwarding plane 70. The flow table update request 82 consists of information indicating the port changes to be made with respect to traffic flow(s) passing through the network element 20(i) for the host that has moved. For example, the port changes may involve changes to an output port to which packets for a flow associated with the host need to be forwarded out of the network element 20(i). The forwarding plane 70 processes the flow update request 82 to update a flow table for the host traffic flow(s). If the forwarding plane 70 successfully makes the flow table update request 82, then the forwarding plane 70 sends flow table update success 84 to the control plane 60. If for whatever reason, the flow table update cannot be made by the forwarding plane 70, then the forwarding plane 70 will not send a flow table update success 84 to the control plane 60. The control plane 60 will send a response (indicating update success or failure) 86 to the controller 30 indicating whether the network element successfully updated its flow table based on the flow table update contained in the request 80. Based on the response 86, the controller 30 will then know whether or not the flow table update change was successfully made. The controller 30 performs this update process depicted in FIG. 4 for each network element 20(i) to which the flow table update needs to be made. If the controller 30 receives a response indicating that the network element did not successfully update its flow table, then the controller 30 may terminate updating of further network elements in the network.

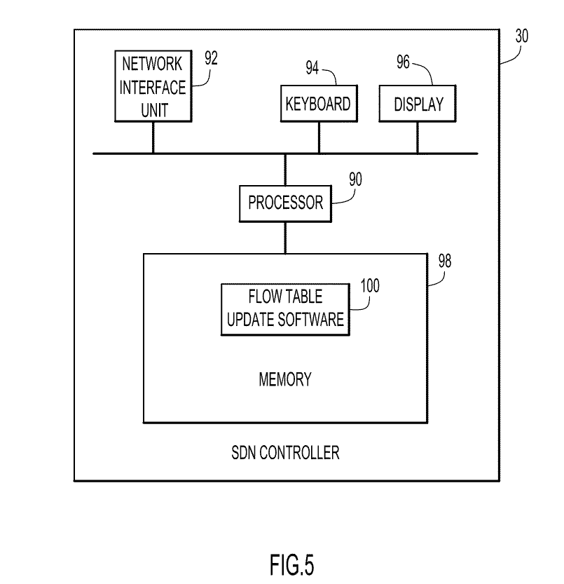

Reference is now made to FIG. 5 that shows an example block diagram of the SDN controller 30. The SDN controller 30 may be a computing apparatus, e.g., a server computer, or a virtual machine running on a physical server computer. The computing apparatus comprises a processor 90 (or several processors), a network interface unit 92 (e.g., one or more network interface cards), one or more input/output devices such as a keyboard 94 and display 96, and a memory 98. The memory 98 stores instructions for flow table update software 100. The processor 90 executes the instructions for the flow table update software 100 to perform the operations described above in connection with FIGS. 1-4. The memory 98 may comprise read only memory (ROM), random access memory (RAM), magnetic disk storage media devices, optical storage media devices, flash memory devices, electrical, optical, or other physical/tangible memory storage devices. The processor 90 is, for example, a microprocessor or microcontroller that executes instructions for the flow table update software 100. Thus, in general, the memory 98 may comprise one or more tangible (non-transitory) computer readable storage media (e.g., a memory device) encoded with software comprising computer executable instructions and when the software is executed (by the processor 90) it is operable to perform the operations described herein.

The techniques presented herein provide a way to process the OpenFlow/SDN signaling messages in order to maintain the dependency checks to avoid network loop and outage.

In summary, from a method perspective, a method is provided comprising: at a controller, storing data representing a topology of a network that includes a plurality of network elements; detecting a move of a host between network elements in the network and determining a destination network element to which the host has moved; designating the destination network element as a root of a tree in the network; generating a topology for the tree using the destination network element as the root of the tree; and following the topology of the tree, starting with the root, updating parent network elements in the tree before updating child network elements.

Similarly, a computer readable storage media is provided that is encoded with software comprising computer executable instructions and when the software is executed operable to: at a controller, store data representing a topology of a network that includes a plurality of network elements; detect a move of a host between network elements in the network and determining a destination network element to which the host has moved; designate the destination network element as a root of a tree in the network; generate a topology for the tree using the destination network element as the root of the tree; and follow the topology of the tree, starting with the root, updating parent network elements in the tree before updating child network elements.

An apparatus is also provided comprising: a network interface unit configured to enable communications over a network; a memory configured to store data representing a topology of a network that includes a plurality of network elements; and a processor coupled to the network interface unit and the memory. The processor configured to: detect a move of a host between network elements in the network and determining a destination network element to which the host has moved; designate the destination network element as a root of a tree in the network; generate a topology for the tree using the destination network element as the root of the tree; and follow the topology of the tree, starting with the root, updating parent network elements in the tree before updating child network elements.

The above description is intended by way of example only.

What is claimed is:

1. A method comprising:
at a controller, storing data representing a topology of a network that includes a plurality of network elements;
detecting a move of a host between network elements in the network and determining a destination network element to which the host has moved;
designating the destination network element as a root of a tree in the network;
generating a topology for the tree using the destination network element as the root of the tree; and
following the topology of the tree, starting with the root, updating parent network elements in the tree before updating child network elements.

2. The method of claim 1, further wherein updating comprises updating flow table changes of network elements associated with the movement of the host so as to avoid a network traffic loop or outage.

3. The method of claim 1, wherein storing data comprises storing data representing the topology of physical and/or virtual switches in the network.

4. The method of claim 1, wherein generating the topology for the tree comprises generating a minimal spanning tree topology.

5. The method of claim 1, wherein generating the topology for the tree comprises generating the topology on the basis of network elements that are impacted by movement of the host and without regard to network elements not impacted by movement of the host.

6. The method of claim 1, wherein updating comprises sending from the controller to a network element to be updated a request containing a flow table update, and receiving a response from the network element, the response indicating whether the network element successfully updated its flow table.

7. The method of claim 6, wherein updating comprises terminating updating of further network elements if update of a network element is not successful.

8. The method of claim 1, wherein updating comprises simultaneously updating two or more network elements if their parent network element has already been updated.

9. One or more computer readable storage media encoded with software comprising computer executable instructions and when the software is executed operable to:
at a controller, store data representing a topology of a network that includes a plurality of network elements;
detect a move of a host between network elements in the network and determining a destination network element to which the host has moved;
designate the destination network element as a root of a tree in the network;
generate a topology for the tree using the destination network element as the root of the tree; and
follow the topology of the tree, starting with the root, updating parent network elements in the tree before updating child network elements.

10. The computer readable storage media of claim 9, wherein the instructions operable to generate comprise instructions operable to generate the topology for the tree comprises generating a minimal spanning tree topology.

11. The computer readable storage media of claim 9, wherein the instructions operable to update comprise instructions operable to send to a network element to be updated a request containing a flow table update, and receive a response from the network element, the response indicating whether the network element successfully updated its flow table.

12. The computer readable storage media of claim 9, further comprising instructions operable to terminate updating of further network elements if update of the network element is not successful.

13. The computer readable storage media of claim 9, wherein the instructions operable to update comprise instructions operable to simultaneously update two or more child nodes that are at the same level of the tree.

14. The computer readable storage media of claim 9, wherein the instructions operable to update comprise instructions operable to update flow table changes of network elements associated with the movement of the host so as to avoid a network traffic loop or outage.

15. An apparatus comprising:
a network interface unit configured to enable communications over a network;
a memory configured to store data representing a topology of a network that includes a plurality of network elements; and
a processor coupled to the network interface unit and the memory, the processor configured to:
detect a move of a host between network elements in the network and determining a destination network element to which the host has moved;
designate the destination network element as a root of a tree in the network;
generate a topology for the tree using the destination network element as the root of the tree; and
follow the topology of the tree, starting with the root, updating parent network elements in the tree before updating child network elements.

16. The apparatus of claim 15, wherein the processor is configured to update flow table changes of network elements associated with the movement of the host so as to avoid a network traffic loop or outage.

17. The apparatus of claim 15, wherein the processor is configured to generate the topology for the tree comprises generating a minimal spanning tree topology.

18. The apparatus of claim 15, wherein the processor is configured to send to a network element to be updated a request containing a flow table update, and receive a response from the network element, the response indicating whether the network element successfully updated its flow table.

19. The apparatus of claim 18, wherein the processor is configured to terminate updating of further network elements if update of the network element is not successful.

20. The apparatus of claim 15, wherein the memory is configured to store data representing the topology of physical and/or virtual switches in the network.
